(19) United States
(12) Patent Application Publication
(10) Pub. No.: US 2014/0328217 A1
(43) Pub. Date: Nov. 6, 2014

(54) DETECTING QUALITY OF SERVICE AND PRECONDITION CAPABILITIES OF A CORE NETWORK

(71) Applicant: QUALCOMM INCORPORATED, San Diego, CA (US)

(72) Inventors: Subramanyam Bollapragada, San Diego, CA (US); Fahed I. Zawaideh, San Diego, CA (US)

(73) Assignee: QUALCOMM Incorporated, San Diego, CA (US)

(21) Appl. No.: 13/887,114

(22) Filed: May 3, 2013

(51) Int. Cl. H04W 8/02

(52) U.S. Cl. CPC H04W 8/02
USPC 370/259

(57) ABSTRACT

A method for wireless communication by a wireless communication device is disclosed. The wireless communication device roams on a network. The wireless communication device initiates a voice over Internet Protocol call. A response from the network is received. Quality of service capabilities and precondition capabilities of the network are determined from the response. The wireless communication device proceeds with the voice over Internet Protocol call without quality of service preconditions.

### TECHNICAL FIELD

The present disclosure relates generally to wireless communication systems. More specifically, the present disclosure relates to systems and methods for detecting network quality of service (QoS) and precondition capabilities of an IP multimedia system (IMS) core network.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smartphones, computers, etc.) communicate with other electronic devices. For example, a wireless communication device (e.g., cellular phone, smartphone, etc.) may wirelessly communicate with a base station and vice-versa. This may enable the wireless communication device to access and/or communicate voice, video, data and so on.

One major advancement in wireless communications is the use of voice over Internet Protocol (VoIP). Voice over Internet Protocol (VoIP) allows for the delivery of voice communications and multimedia sessions over Internet Protocol (IP) networks, such as the Internet. The use of voice over Internet Protocol (VoIP) may reduce the communication and infrastructure costs. Benefits may be realized by improvements to the usage of voice over Internet Protocol (VoIP).

### BRIEF DESCRIPTION OF THE DRAWINGS

FIG. 1 shows a wireless communication system with multiple wireless devices;

FIG. 2 is a block diagram illustrating an architectural overview of the IP multimedia system (IMS) core network;

FIG. 3 is a block diagram illustrating the implementation of an IP multimedia system (IMS) core network as a back-to-back user agent (B2BUA);

FIG. 4 is a flow diagram of a method for determining quality of service (QoS)/precondition capabilities of a network;

FIG. 5 is a flow diagram of a method for removing quality of service (QoS) precondition headers from voice over Internet Protocol (VoIP) call requests and responses;

FIG. 6 shows part of a hardware implementation of an apparatus for executing the voice over Internet Protocol (VoIP) methods described herein; and

FIG. 7 shows part of a hardware implementation of an apparatus for executing the voice over Internet Protocol (VoIP) methods described herein.

### DETAILED DESCRIPTION

A wireless communication device may be roaming on a network (i.e., a network that is not the home network of the wireless communication device). The wireless communication device may be unaware of the configurations/abilities of the network. For example, the wireless communication device may be unaware of the quality of service capabilities of the network and/or the precondition capabilities of the network. The wireless communication device may be unable to complete a voice over Internet Protocol (VoIP) call with the network if the wireless communication device is unaware of the quality of service and/or precondition capabilities of the network. However, if the wireless communication device is configured to determine these capabilities of the network, based on a response from the network to the initiation of a voice over Internet Protocol (VoIP) call, the wireless communication device may be able to adjust settings and complete the voice over Internet Protocol (VoIP) call.

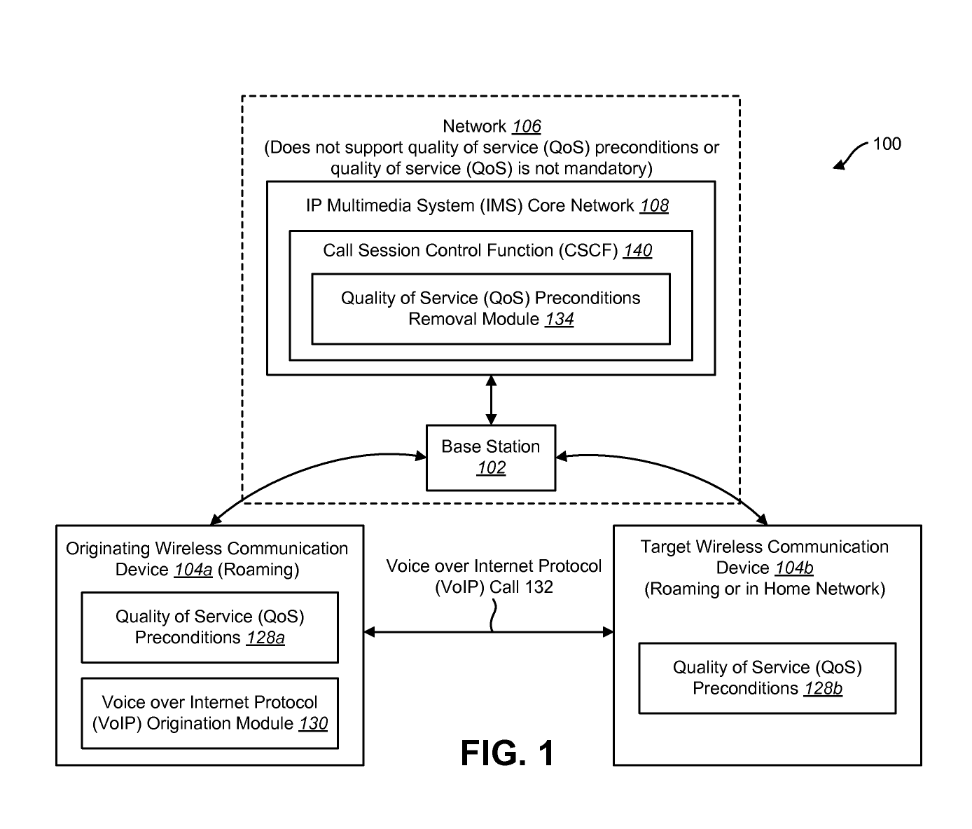

FIG. 1 shows a wireless communication system 100 with multiple wireless devices. Wireless communication systems 100 are widely deployed to provide various types of communication content such as voice, data and so on. A wireless device may be a base station 102 or a wireless communication device 104. A wireless communication device 104 may be configured to initiate/receive voice over Internet Protocol (VoIP) calls 132 with other wireless communication devices 104. Wireless communication devices 104 and networks 106 may each be configured such that a wireless communication device 104 can determine quality of service (QoS) precondition capabilities of the network 106. This allows a wireless communication device 104 to determine an acceptable data rate for voice over Internet Protocol (VoIP) calls 132 that can be supported by the network 106.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, etc.

A wireless communication device 104 may communicate with zero, one or multiple base stations 102 on the downlink and/or uplink at any given moment. The downlink (or forward link) refers to the communication link from a base station 102 to a wireless communication device 104, and the uplink (or reverse link) refers to the communication link from a wireless communication device 104 to a base station 102.

A network 106 may be a home network 106 or a visiting network 106 (from the perspective of a wireless communication device 104). For example, a home network 106 may be a network 106 that a wireless communication device 104 has an operating agreement with (such as a cell phone provider) while a visiting network 106 is a network 106 that a wireless communication device 104 is roaming on (e.g., no operating agreement). Typically, the settings of a wireless communication device 104 coincide with the settings of a home network 106 but may vary from those of a visiting network 106. As used herein, the network 106 either does not support quality of service (QoS) preconditions or quality of service (QoS) is not mandatory in the network.

In one configuration, a network 106 may be aware of quality of service (QoS) requirements and/or preconditions. Thus, the network 106 may support precondition headers in session initiation protocol (SIP) signaling communication between the network 106 and the user agents (UAs). The network 106 may trigger the quality of service (QoS) procedure and the radio bearer configuration with the base station 102. The network 106 may also indicate to the user agent (UA), while one of the components is acting as a back-to-back user agent (B2BUA), that the originating wireless communication device 104a supports quality of service (QoS) preconditions by passing the quality of service (QoS) precondition header from the originating wireless communication device 104a to the target wireless communication device 104b. The precondition header may include information such as the current quality of service (QoS) strength for the call and the desired quality of service (QoS) strength for the call. The precondition header may also include the parameters defined in the 3GPP 24.229 specification, such as whether local equals mandatory or optional and whether remote equals mandatory or optional.

Both an originating wireless communication device 104a and a target wireless communication device 104b are illustrated as being in communication with the network 106. The originating wireless communication device 104a and the target wireless communication device 104b may each be camped on a single base station 102 or separate base stations. The originating wireless communication device 104a may originate a voice over Internet Protocol (VoIP) call 132 with the target wireless communication device 104b using a voice over Internet Protocol (VoIP) origination module 130. The originating wireless communication device 104a may be configured with quality of service (QoS) preconditions 128a. The originating wireless communication device 104a may be roaming on the network 106 (and thus the network 106 is a visiting network 106 from the perspective of the originating wireless communication device 104a). The originating wireless communication device 104a may be unaware of the quality of service (QoS) configuration of the network 106. For example, the originating wireless communication device 104a may be unaware whether the network 106 supports quality of service (QoS) preconditions 128, whether the network 106 does not support quality of service (QoS) preconditions 128 or whether quality of service (QoS) is not mandatory for the network 106.

Currently, if the originating wireless communication device 104a is configured with quality of service (QoS) preconditions 128 as mandatory and the quality of service (QoS) or preconditions are not met, then the originating wireless communication device 104a would never be able to complete a voice over Internet Protocol (VoIP) call 132 in a network 106 that does not support quality of service (QoS) preconditions 128 or where quality of service (QoS) is not mandatory. This is because the originating wireless communication device 104a is unable to detect, based on the message exchange with the target wireless communication device 104b (which passes through an IP multimedia system (IMS) core network 108 that is part of the network 106), that the network 106 does not support quality of service (QoS) preconditions 128a. If the originating wireless communication device 104a cannot detect the quality of service (QoS) precondition settings of the network 106, the originating wireless communication device 104a may switch quality of service (QoS) to mandatory, which results in a failed voice over Internet Protocol (VoIP) call 132 attempt. Instead, the originating wireless communication device 104a will release the call in progress. The specifications have not defined a mechanism for the originating wireless communication device 104a to determine that the network 106 does not support quality of service (QoS) preconditions 128, which would allow the originating wireless communication device 104a to proceed with a voice over Internet Protocol (VoIP) call 123 even if the quality of service (QoS) preconditions 128 are not met or quality of service (QoS) is not setup in the network 106.

The originating wireless communication device 104a may be configured to use session initiation protocol (SIP) or other protocols that are designed to replace session initiation protocol (SIP) for session configuration. A session configuration that uses these protocols may carry precondition headers or equivalents.

The originating wireless communication device 104a may include one or more clients. For example, the originating wireless communication device 104a may include a session initiation protocol (SIP) client, a voice over Internet Protocol (VoIP) client, a video telephony client or an IP multimedia system (IMS) client. The client on the originating wireless communication device 104a may refer to the program on the originating wireless communication device 104a that is used to initiate a voice or data call with the network 106.

The target wireless communication device 104b may either be roaming or located in a home network 106. If the target wireless communication device 104b is in a home network 106, then the target wireless communication device 104b will include the same settings as the network 106 (in this scenario the target wireless communication device 104b will be configured like the home network 106 where quality of service (QoS) is either not mandatory or the target wireless communication device 104b does not support preconditions). If the target wireless communication device 104b is roaming, the target wireless communication device 104b may be configured with quality of service (QoS) preconditions 128b. However, a target wireless communication device 104b that is roaming may not be configured to support preconditions or quality of service (QoS) may not be mandatory for the target wireless communication device 104b.

A wireless communication device 104 may utilize the IP multimedia system (IMS) core network 108 for data services and/or voice services. One of the principle functions of the IP multimedia system (IMS) core network 108 may be to route voice calls between wireless communication devices 104. The IP multimedia system (IMS) core network 108 may include a call session control function (CSCF) 140. In one configuration, the call session control function (CSCF) 140 may be a computer (i.e., a distinct piece of hardware). The call session control function (CSCF) 140 may include a quality of service (QoS) preconditions removal module 134. The call session control function (CSCF) 140 may act as a back-to-back user agent (B2BUA) when forwarding session initiation protocol (SIP) messages.

The 3^{rd} Generation Partnership Project (3GPP) includes a requirement that, in order to allow a peer entity to reserve the required resources for a voice over Internet Protocol (VoIP) call 132, an originating wireless communication device 104a that supports the precondition mechanism should indicate to the peer entity that the originating wireless communication device 104a supports quality of service (QoS). The originating wireless communication device 104a may also indicate to the peer entity that the originating wireless communication device 104a requires quality of service (QoS) as mandatory for the type of service being proposed in the INVITE method. This is the case even when the originating wireless communication device 104a does not require quality of service (QoS) resources reserved locally (i.e., at the base station 102 that the originating wireless communication device 104a is camped on).

In a home network 106, this is not problematic, since a wireless communication device 104 that supports the precondition mechanism is correlated with a home network 106 that also supports the precondition mechanism. If an operator of a network 106 configures a wireless communication device 104 to use the precondition mechanism, then an originating wireless communication device 104a will indicate a “precondition” option-tag within the Require-header field (the interworking with the target wireless communication device 104b that does not support the precondition mechanism).

In a visiting network 106 where a wireless communication device 104 is roaming, the wireless communication device 104 may be unable to determine whether the network 106 supports the precondition mechanism. Such scenarios are not described in any specification of the 3GPP standards (including 3GPP 24.229). Thus, if the visiting network 106 does not support the precondition mechanism, voice over Internet Protocol (VoIP) calls 132 originated by a wireless communication device 104 that supports the precondition mechanism will fail. This may occur if the visiting network 106 does not support quality of service (QoS) preconditions or if quality of service (QoS) is configured in the network 106 as mandatory for the service but quality of service (QoS) resources were not allocated.

If the network 106 does not support the precondition mechanism, the call session control function (CSCF) 140 may use the quality of service (QoS) preconditions removal module 134 to facilitate the setting up of a voice over Internet Protocol (VoIP) call 132 between an originating wireless communication device 104a and a target wireless communication device 104b). Upon receiving a request for a voice over Internet Protocol (VoIP) call 132 from an originating wireless communication device 104a that includes quality of service (QoS) preconditions 128a or that specifies that the use of preconditions is mandatory, the quality of service (QoS) preconditions removal module 134 may remove the quality of service (QoS) precondition headers from the request prior to forwarding the request to the target wireless communication device 104b. Thus, in one configuration the target wireless communication device 104b may receive a request for a voice over Internet Protocol (VoIP) call 132 from the IP multimedia system (IMS) core network 108 that does not include quality of service (QoS) precondition headers.

The quality of service (QoS) preconditions removal module 134 may also remove quality of service (QoS) precondition headers out of a response received from the target wireless communication device 104b. The call session control function (CSCF) 140 may then forward the response to the originating wireless communication device 104a, facilitating the setup of the voice over Internet Protocol (VoIP) call 132.

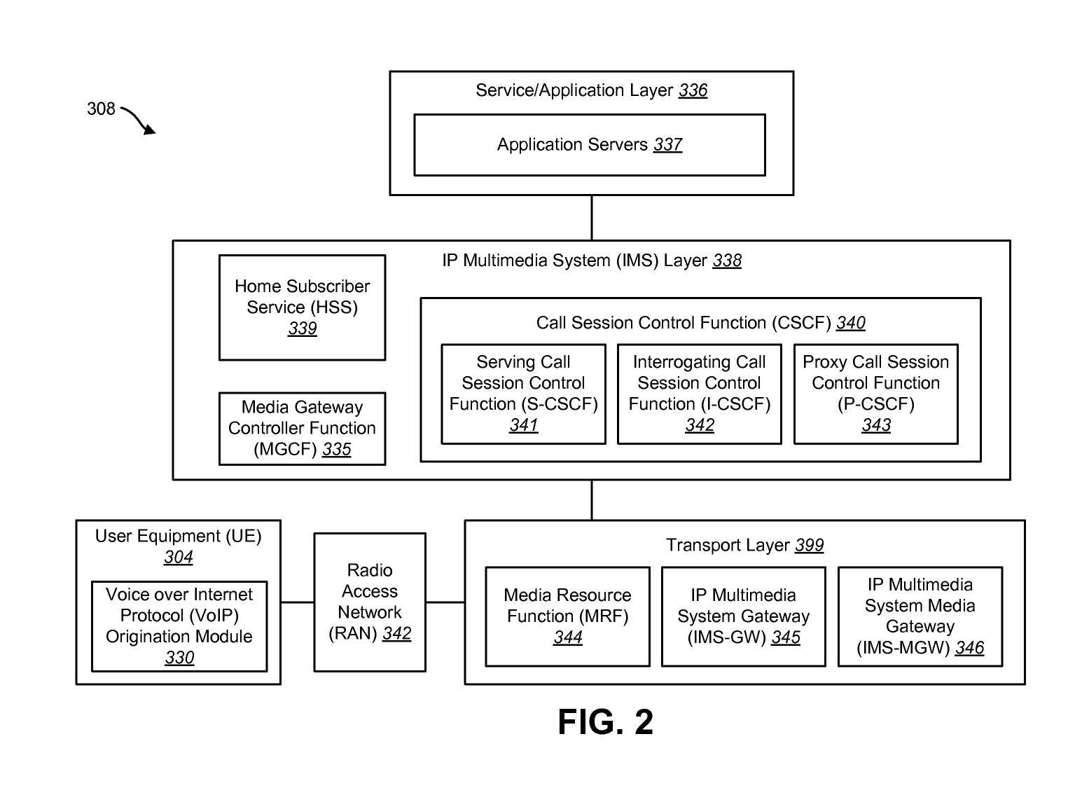

FIG. 2 is a block diagram illustrating an architectural overview of the IP multimedia system (IMS) core network 308. The IP multimedia system (IMS) core network 308 may be a collection of different functions that are linked by standardized interfaces. Each function may be combined with other functions in nodes (e.g., hardware boxes) or a function may be spread across multiple nodes. Each node may be present multiple times within a single network for dimensioning, load balancing or organizational issues.

The IP multimedia system (IMS) core network 308 may include a service/application layer 336, an IP multimedia system (IMS) layer 338 and a transport layer 399. The service/application layer 336 may include application servers 337 that interface with the IP multimedia system (IMS) layer 338. The application servers 337 may host and execute services for a user.

The IP multimedia system (IMS) layer 338 may include the home subscriber service (HSS) 339, which is a master user database that supports the IP multimedia system (IMS) network entities that actually handle calls. The home subscriber service (HSS) 399 includes subscription-related information, performs authentication and authorization, and can provide information about the subscriber's location and IP information. The IP multimedia system (IMS) layer 338 may also include a media gateway controller function (MGCF) 335. The media gateway controller function (MGCF) 335 may be a session initiation protocol (SIP) endpoint that does call control protocol conversion.

The IP multimedia system (IMS) layer may include a call session control function (CSCF) 340. The call session control function (CSCF) 340 may be used to process session initiation protocol (SIP) signaling packets in the IP multimedia system (IMS) core network 308. The call session control function (CSCF) 340 may include a proxy call session control function (P-CSCF) 343, a serving call session control function (S-CSCF) 341 and an interrogating call session control function (I-CSCF) 342. The proxy call session control function (P-CSCF) 343 may be a session initiation protocol (SIP) proxy that provides subscriber authentication, inspects signaling, compresses and decompresses session initiation protocol (SIP) messages and generates charging records. The serving call session control function (S-CSCF) 341 is a session initiation protocol (SIP) server that also performs session control. The serving call session control function (S-CSCF) 341 handles session initiation protocol (SIP) registrations, decides which application servers session initiation protocol (SIP) message are forwarded to and provides routing services. The interrogating call session control function (I-CSCF) 342 queries the home subscriber service (HSS) 339 to retrieve the address of the serving call session control function (S-CSCF) 341 and assigns this address to a user performing session initiation protocol (SIP) registration.

The transport layer 399 may include an IP multimedia system gateway (IMS-GW) 345, an IP multimedia system media gateway (IMS-MGW) and a media resource function (MRF) 344. A user equipment (UE) 304 may communicate with the transport layer 399 of the IP multimedia system (IMS) core network 308 via a radio access network (RAN) 342. The radio access network (RAN) 342 may include a base station 102 (such as an eNode B). The user equipment (UE) 304 of FIG. 2 may be one configuration of the originating wireless communication device 104 of FIG. 1. The user equipment (UE) 304 may thus include a voice over Internet Protocol (VoIP) origination module 330 that allows the user equipment (UE) 304 to initiate voice over Internet Protocol (VoIP) calls while roaming in a network that might not support preconditions or quality of service (QoS).

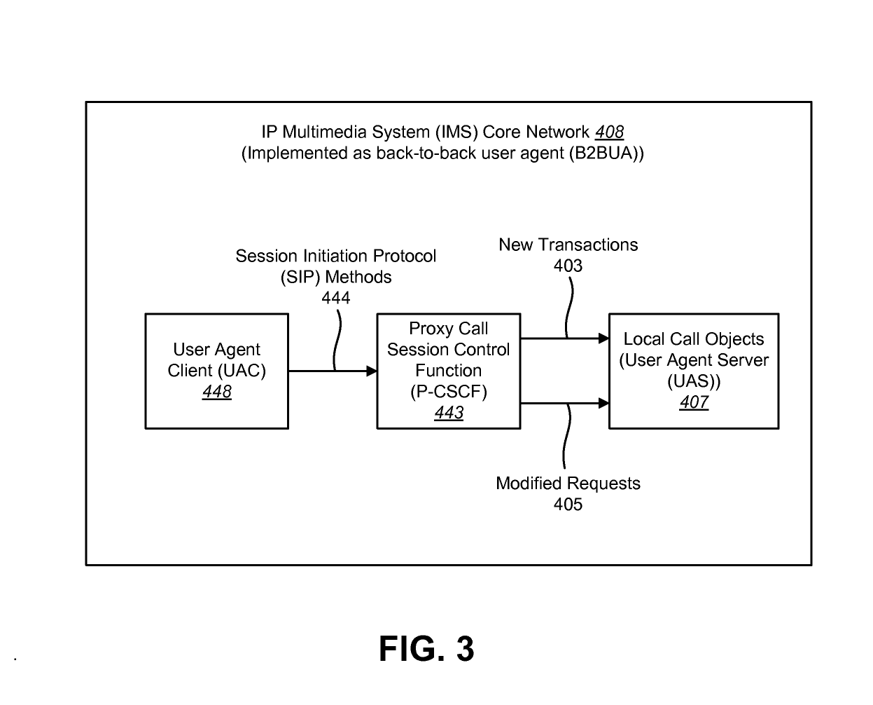

FIG. 3 is a block diagram illustrating the implementation of an IP multimedia system (IMS) core network 408 as a back-to-back user agent (B2BUA). The proxy call session control function (P-CSCF) 443 may receive incoming session initiation protocol (SIP) methods 444 from a user agent client (UAC) 448. The proxy call session control function (P-CSCF) 443 may read the session initiation protocol (SIP) methods 444. The proxy call session control function (P-CSCF) 443 may create local call objects 407 that act as the user agent server (UAS) to the originating side. The proxy call session control function (P-CSCF) 443 may also start new transactions 403. The proxy call session control function (P-CSCF) 443 may modify the request received from an originating wireless communication device 104a. The modified requests 405 may be provided to the local call objects 407 acting as a user agent server (UAS), while the back-to-back user agent (B2BUA) acts as a user agent client (UAC).

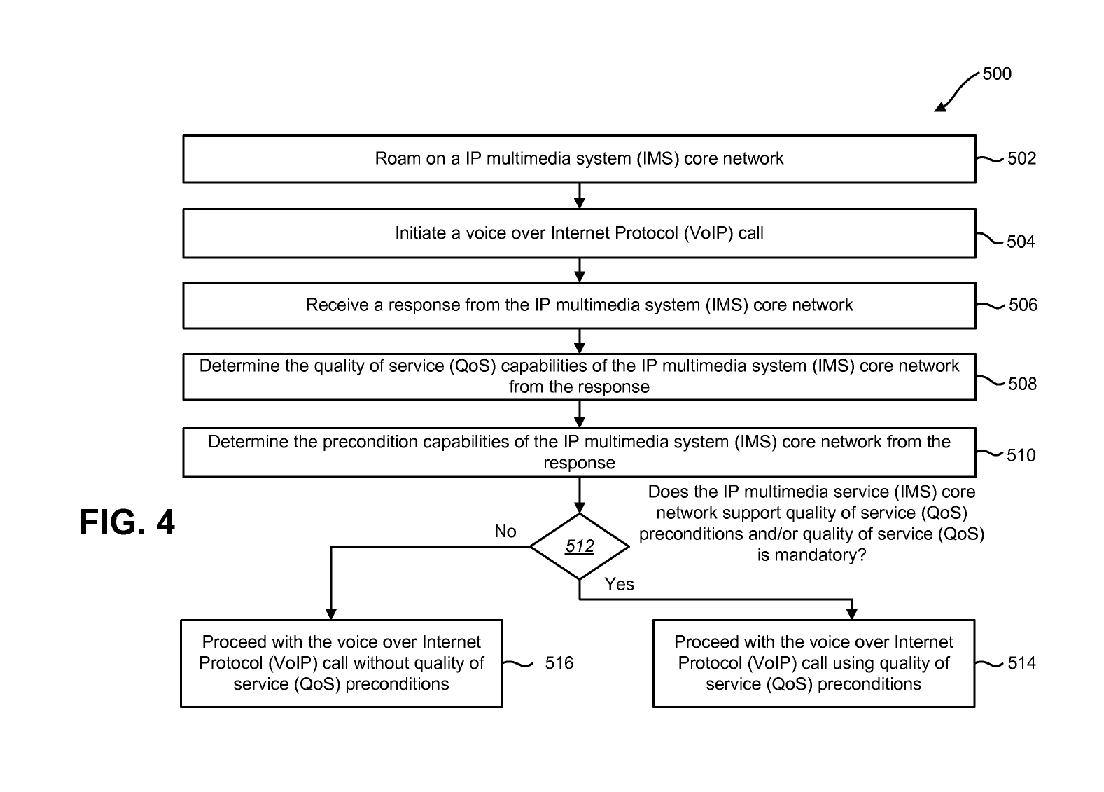

FIG. 4 is a flow diagram of a method 500 for determining quality of service (QoS) and precondition capabilities of an IMS core network 108. The method 500 may be performed by an originating wireless communication device 104a. The originating wireless communication device 104a may roam 502 on a network 106 (i.e., the network 106 is not the home network 106 of the originating wireless communication device 104a). In one configuration, an IP multimedia system (IMS) core network 108 within the network 106 may not support quality of service (QoS) preconditions. In another configuration, quality of service (QoS) may not be mandatory in the IP multimedia system (IMS) core network 108. The originating wireless communication device 104a may roam 502 on the IP multimedia system (IMS) core network 108 using a combination of one or more antennas, a processor and memory on the originating wireless communication device 104a.

The originating wireless communication device 104a may initiate 504 a voice over Internet Protocol (VoIP) call 132 with a target wireless communication device 104b. The voice over Internet Protocol (VoIP) call 132 may be initiated 504 using one or more antennas, a processor and/or memory in the originating wireless communication device 104a. In one configuration, the target wireless communication device 104b may be configured with quality of service (QoS) preconditions 128b. In this configuration, the target wireless communication device 104b may either be roaming on the network 106 (that includes the IP multimedia system (IMS) core network 108) or the IP multimedia system (IMS) core network 108 may be part of the home network 106 for the target wireless communication device 104b. In another configuration, the target wireless communication device 104b may not be configured with quality of service (QoS) preconditions 128b. In this configuration, the target wireless communication device 104b may be roaming on the network 106.

The IP multimedia system (IMS) core network 108 may act as a back-to-back user agent (B2BUA) when the originating wireless communication device 104a initiates 504 a voice over Internet Protocol (VoIP) call 132. Thus, when the originating wireless communication device 104a initiates 504 a voice over Internet Protocol (VoIP) call 132 that has preconditions or where preconditions are mandatory, in some configurations, the IP multimedia system (IMS) core network 108 may remove the quality of service (QoS) precondition headers from the voice over Internet Protocol (VoIP) call request before forwarding the voice over Internet Protocol (VoIP) call request to the target wireless communication device 104b. The target wireless communication device 104b then sends a response back to the IP multimedia system (IMS) core network 108.

If the target wireless communication device 104b does not require quality of service (QoS) preconditions 128b, the response will not include quality of service (QoS) precondition headers. If the target wireless communication device 104b does require quality of service (QoS) preconditions 128b, the IP multimedia system (IMS) core network 108 (acting as a back-to-back user agent (B2BUA)) may remove the quality of service (QoS) precondition headers from the response. The IP multimedia system (IMS) core network 108 may then forward the response to the originating wireless communication device 104a. The originating wireless communication device 104a may thus receive 506 a response from the IP multimedia system (IMS) core network 108. In one configuration, the originating wireless communication device 104a may receive 506 a response from the IP multimedia system (IMS) core network 108 using one or more antennas, a processor and/or memory.

The originating wireless communication device 104a may determine 508 the quality of service (QoS) capabilities of the IP multimedia system (IMS) core network 108 from the response. The originating wireless communication device 104a may also determine 510 the precondition capabilities of the IP multimedia system (IMS) core network 108 from the response. For example, the originating wireless communication device 104a may determine that the response does not include quality of service (QoS) precondition headers (and thus, that the IP multimedia system (IMS) core network 108 either does not support quality of service (QoS) preconditions or quality of service (QoS) is not mandatory in the IP multimedia system (IMS) core network 108). Likewise, if the response does include precondition headers, the originating wireless communication device 104a can determine from the precondition headers whether the IP multimedia system (IMS) core network 108 supports precondition headers or whether quality of service (QoS) is mandatory. In one configuration, the originating wireless communication device 104a may determine the quality of service (QoS)/precondition capabilities of the IP multimedia system (IMS) core network 108 from the response using hardware, such as comparators, processors and memory.

The originating wireless communication device 104b may then determine 512 whether the IP multimedia system (IMS) core network 108 supports quality of service (QoS) preconditions and/or quality of service (QoS) is mandatory. If the originating wireless communication device 104b determines that the IP multimedia system (IMS) core network 108 supports quality of service (QoS) preconditions and/or quality of service (QoS) is mandatory, then the originating wireless communication device 104b may proceed 514 with the voice over Internet Protocol (VoIP) call 132 using quality of service (QoS) preconditions 128a.

If the originating wireless communication device 104b determines that the IP multimedia system (IMS) core network 108 does not support quality of service (QoS) preconditions and/or quality of service (QoS) is not mandatory, then the originating wireless communication device 104b may proceed 516 with the voice over Internet Protocol (VoIP) call 132 without quality of service (QoS) preconditions 128a. For example, the originating wireless communication device 104a may proceed 516 even though the quality of service (QoS) preconditions 128a have not been met or quality of service (QoS) is not setup. In one configuration, the originating wireless communication device 104a may proceed 516 with the voice over Internet Protocol (VoIP) call 132 without quality of service (QoS) preconditions 128a using one or more antennas, processors and memory.

When the originating wireless communication device 104a is operating in a home network 106, the originating wireless communication device 104a may keep the quality of service (QoS) preconditions 128a settings configured in the home network 106.

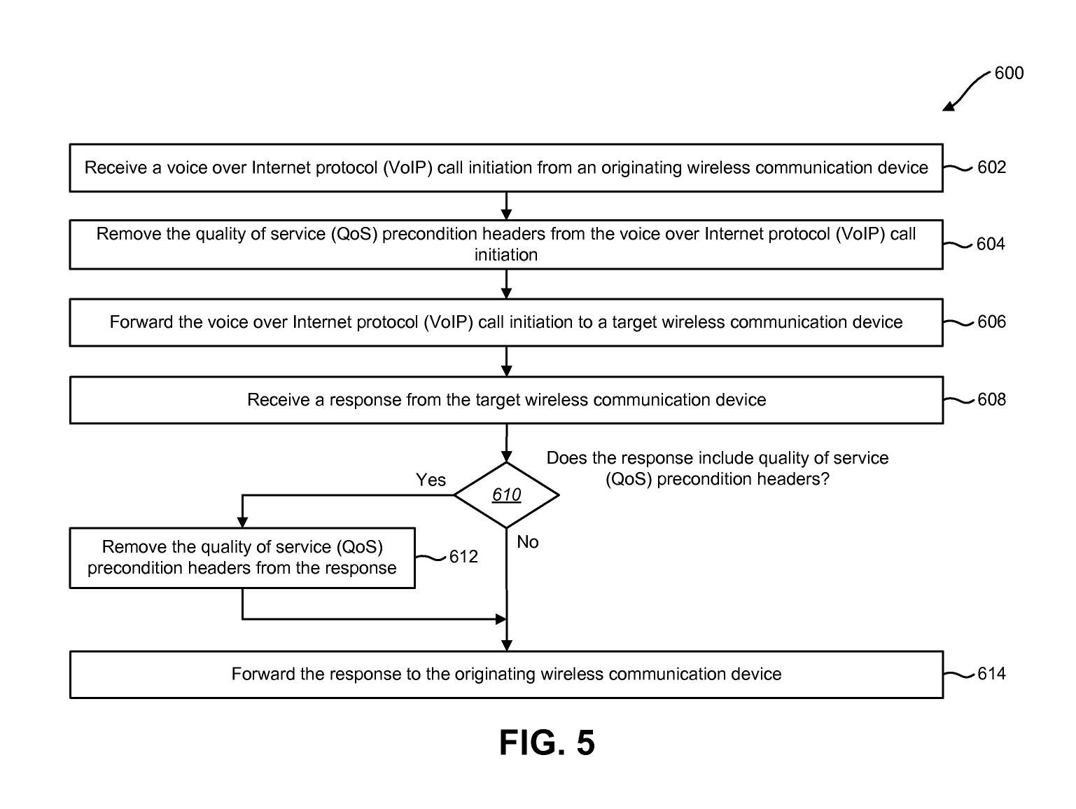

FIG. 5 is a flow diagram of a method 600 for removing quality of service (QoS) precondition headers from voice over Internet Protocol (VoIP) call 132 requests and responses. The method 600 may be performed by a call session control function (CSCF) 140 within the network 106. The call session control function (CSCF) 140 may receive 602 a voice over Internet Protocol (VoIP) call 132 initiation from an originating wireless communication device 104a. The voice over Internet Protocol (VoIP) call 132 initiation may include quality of service (QoS) precondition headers. The originating wireless communication device 104b may be roaming on the network 106. In one configuration, the voice over Internet Protocol (VoIP) call 132 initiation may be received 602 by an antenna on the call session control function (CSCF) 140.

The call session control function (CSCF) 140 may remove 604 the quality of service (QoS) precondition headers from the voice over Internet Protocol (VoIP) call 132 initiation. In one configuration, the call session control function (CSCF) 140 may remove 604 the quality of service (QoS) precondition headers from the voice over Internet Protocol (VoIP) call 132 initiation using one or more processors and memory. As discussed above, a precondition header may include information such as the current quality of service (QoS) strength for the call and the desired quality of service (QoS) strength for the call. By removing the precondition headers, the call session control function (CSCF) 140 may indicate to the target wireless communication device 104b and the originating wireless communication device 104a that the network 106 does not support quality of service (QoS) requirements and/or preconditions.

The call session control function (CSCF) 140 may then forward 606 the voice over Internet Protocol (VoIP) call 132 initiation to a target wireless communication device 104b. The call session control function (CSCF) 140 may receive 608 a response from the target wireless communication device 104b. The call session control function (CSCF) 140 may determine 610 whether the response includes quality of service (QoS) precondition headers. If the target wireless communication device 104b is not roaming (and thus the network 106 is the home network 106 for the target wireless communication device 104b), the response will not include quality of service (QoS) precondition headers. If the target wireless communication device 104b is roaming, the response may include quality of service (QoS) precondition headers if the target wireless communication device 104b is configured to use quality of service (QoS) preconditions 128b or quality of service (QoS) is mandatory for the target wireless communication device 104b.

If the response includes quality of service (QoS) precondition headers, the call session control function (CSCF) 140 may remove 612 the quality of service (QoS) precondition headers from the response. The call session control function (CSCF) 140 may then forward 614 the response to the originating wireless communication device 104a. If the response does not include quality of service (QoS) precondition headers, the call session control function (CSCF) 140 may forward 614 the response to the originating wireless communication device 104a.

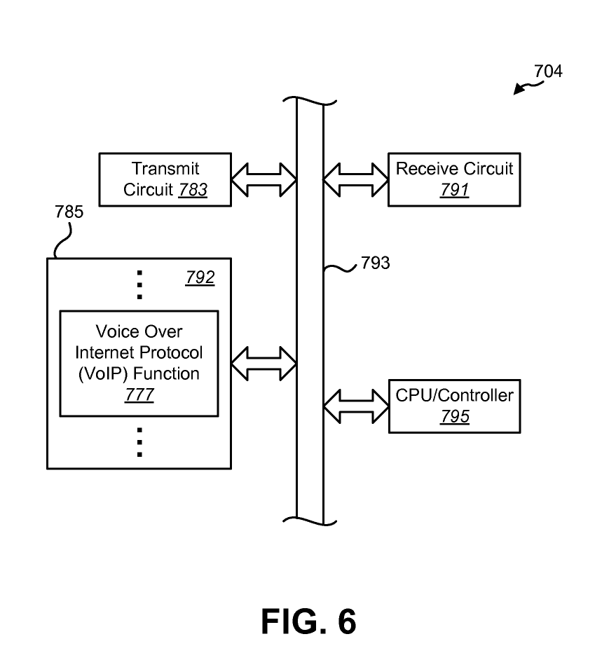

FIG. 6 shows part of a hardware implementation of an apparatus 704 for executing the schemes or processes as described above. The apparatus 704 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 6.

In this embodiment, the circuit apparatus is signified by the reference numeral 704 and can be implemented in a wireless communication device 104 or user equipment (UE) 204 described above.

The apparatus 704 comprises a central data bus 793 linking several circuits together. The circuits include a CPU (central processing unit) or a controller 795, a receive circuit 791, a transmit circuit 783, and a memory unit 785.

The receive circuit 791 and the transmit circuit 783 can be connected to an RF (radio frequency) circuit (which is not shown in the drawing). The receive circuit 791 processes and buffers received signals before sending the signals out to the data bus 793. On the other hand, the transmit circuit 783 processes and buffers the data from the data bus 793 before sending the data out of the apparatus 704. The CPU/controller 795 performs the function of data management of the data bus 793 and furthers the function of general data processing, including executing the instructional contents of the memory unit 785.

The memory unit 785 includes a set of modules and/or instructions generally signified by the reference numeral 792. In this embodiment, the modules/instructions include, among other things, a voice over Internet Protocol (VoIP) function 777 which carries out the schemes and processes as described above. The function 777 includes computer instructions or code for executing the process steps as shown and described in FIGS. 1-6. Specific instructions particular to an entity can be selectively implemented in the function 777. For instance, if the apparatus 704 is part of a wireless communication device 104, among other things, instructions particular to the wireless communication device 104, as shown and described in FIGS. 1-6 can be coded in the function 777.

In this embodiment, the memory unit 785 is a RAM (Random Access Memory) circuit. The exemplary functions, such as the function 777, include one or more software routines, modules and/or data sets. The memory unit 785 can be tied to another memory circuit (not shown) which can either be of the volatile or nonvolatile type. As an alternative, the memory unit 785 can be made of other circuit types, such as an EEPROM (electrically erasable programmable read only memory), an EPROM (electrical programmable read only memory), a ROM (read only memory), an ASIC (application specific integrated circuit), a magnetic disk, an optical disk, and others well known in the art.

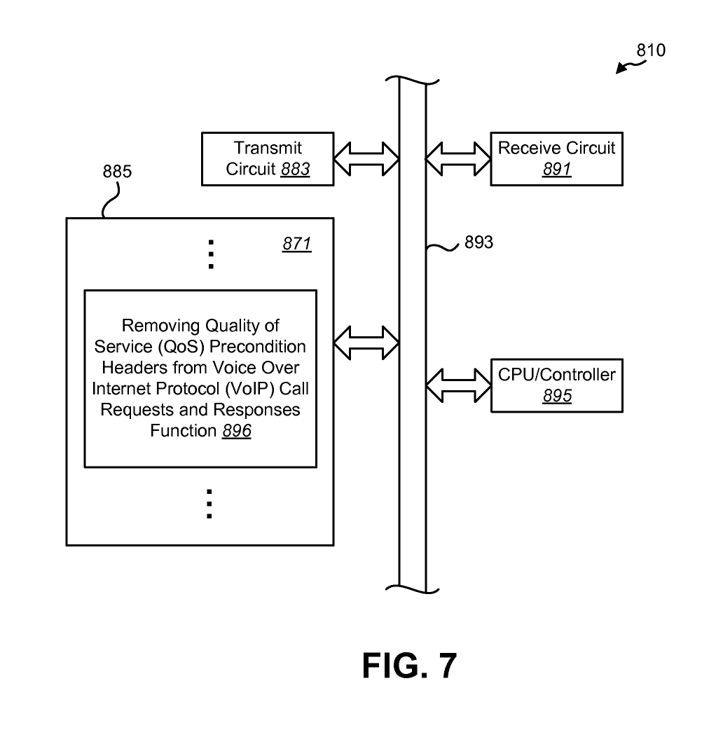

FIG. 7 shows part of a hardware implementation of an apparatus 810 for executing the schemes or processes as described above. The apparatus 810 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 7.

In this embodiment, the circuit apparatus is signified by the reference numeral 810 and can be implemented in a base station 102 or a call session control function (CSCF) 140 described above.

The apparatus 810 comprises a central data bus 893 linking several circuits together. The circuits include a CPU (central processing unit) or a controller 895, a receive circuit 891, a transmit circuit 883, and a memory unit 885.

The receive circuit 891 and the transmit circuit 883 can be connected to an RF (radio frequency) circuit (which is not shown in the drawing). The receive circuit 891 processes and buffers received signals before sending the signals out to the data bus 893. On the other hand, the transmit circuit 883 processes and buffers the data from the data bus 893 before sending the data out of the apparatus 810. The CPU/controller 895 performs the function of data management of the data bus 893 and furthers the function of general data processing, including executing the instructional contents of the memory unit 885.

The memory unit 885 includes a set of modules and/or instructions generally signified by the reference numeral 892. In this embodiment, the modules/instructions include, among other things, a removing quality of service (QoS) precondition headers from voice over Internet Protocol (IP) call requests and responses function 896 which carries out the schemes and processes as described above. The function 896 includes computer instructions or code for executing the process steps as shown and described in FIGS. 1-6. Specific instructions particular to an entity can be selectively implemented in the function 896. For instance, if the apparatus 810 is part of a wireless communication device 104, among other things, instructions particular to the wireless communication device 104, as shown and described in FIGS. 1-6 can be coded in the function 896.

In this embodiment, the memory unit 885 is a RAM (Random Access Memory) circuit. The exemplary functions, such as the function 896, include one or more software routines, modules and/or data sets. The memory unit 885 can be tied to another memory circuit (not shown) which can either be of the volatile or nonvolatile type. As an alternative, the memory unit 885 can be made of other circuit types, such as an EEPROM (electrically erasable programmable read only memory), an EPROM (electrical programmable read only memory), a ROM (read only memory), an ASIC (application specific integrated circuit), a magnetic disk, an optical disk, and others well known in the art.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, include compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus configured for wireless communication, comprising:
means for roaming on a network;
means for initiating a voice over Internet Protocol call;
means for receiving a response from the network;
means for determining quality of service capabilities of the network from the response;
means for determining precondition capabilities of the network from the response; and
means for proceeding with the voice over Internet Protocol call without quality of service preconditions.

2. The apparatus of claim 1, wherein the network is an Internet Protocol multimedia system core network.

3. The apparatus of claim 1, wherein the response does not comprise precondition headers, and wherein the network does not support quality of service preconditions.

4. The apparatus of claim 1, wherein the response does not comprise precondition headers, and wherein quality of service is not mandatory for the network.

5. The apparatus of claim 1, wherein the voice over Internet Protocol call is initiated with a target wireless communication device that is configured with quality of service and preconditions as mandatory, and wherein the target wireless communication device is also roaming on the network.

6. The apparatus of claim 1, wherein the voice over Internet Protocol call is initiated with a target wireless communication device that is not configured with quality of service and preconditions as mandatory, and wherein the target wireless communication device is at a home network.

7. The apparatus of claim 1, wherein a precondition option-tag within a request for the voice over Internet Protocol call indicates that an originating wireless communication device is configured to use a precondition mechanism.

8. The apparatus of claim 1, wherein the apparatus is a wireless communication device that is configured to use a precondition mechanism.

9. The apparatus of claim 1, wherein the apparatus is configured to use a protocol for session configuration that uses precondition headers.

10. The apparatus of claim 1, wherein the apparatus comprises a session initiation protocol client.

11. The apparatus of claim 1, wherein the apparatus comprises a voice over Internet Protocol client.

12. The apparatus of claim 1, wherein the apparatus comprises a video telephony client.

13. The apparatus of claim 1, wherein the apparatus comprises an Internet Protocol multimedia system client.

14. An apparatus, comprising:
circuitry configured to roam on a network, to initiate a voice over Internet Protocol call, to receive a response from the network, to determine quality of service capabilities of the network from the response, to determine precondition capabilities of the network, and to proceed with the voice over Internet Protocol call without quality of service preconditions.

15. The apparatus of claim 14, wherein the network is an Internet Protocol multimedia system core network.

16. The apparatus of claim 14, wherein the response does not comprise precondition headers, and wherein the network does not support quality of service preconditions.

17. The apparatus of claim 14, wherein the response does not comprise precondition headers, and wherein quality of service is not mandatory for the network.

18. The apparatus of claim 14, wherein the voice over Internet Protocol call is initiated with a target wireless communication device that is configured with quality of service and preconditions as mandatory, and wherein the target wireless communication device is also roaming on the network.

19. The apparatus of claim 14, wherein the voice over Internet Protocol call is initiated with a target wireless communication device that is not configured with quality of service and preconditions as mandatory, and wherein the target wireless communication device is at a home network.

20. The apparatus of claim 14, wherein a precondition option-tag within a request for the voice over Internet Protocol call indicates that an originating wireless communication device is configured to use a precondition mechanism.

21. The apparatus of claim 14, wherein the apparatus is a wireless communication device that is configured to use a precondition mechanism.

22. The apparatus of claim 14, wherein the apparatus is configured to use a protocol for session configuration that uses precondition headers.

23. The apparatus of claim 14, wherein the apparatus comprises a session initiation protocol client.

24. The apparatus of claim 14, wherein the apparatus comprises a voice over Internet Protocol client.

25. The apparatus of claim 14, wherein the apparatus comprises a video telephony client.

26. The apparatus of claim 14, wherein the apparatus comprises an Internet Protocol multimedia system client.

27. A method for wireless communication by a wireless communication device, comprising:
roaming on a network;
initiating a voice over Internet Protocol call;
receiving a response from the network;
determining quality of service capabilities of the network from the response;
determining precondition capabilities of network from the response; and
proceeding with the voice over Internet Protocol call without quality of service preconditions.

28. The method of claim 27, wherein the network is an Internet Protocol multimedia system core network.

29. The method of claim 27, wherein the response does not comprise precondition headers, and wherein the network does not support quality of service preconditions.

30. The method of claim 27, wherein the response does not comprise precondition headers, and wherein quality of service is not mandatory for the network.

31. The method of claim 27, wherein the voice over Internet Protocol call is initiated with a target wireless communication device that is configured with quality of service and preconditions as mandatory, and wherein the target wireless communication device is also roaming on the network.

32. The method of claim 27, wherein the voice over Internet Protocol call is initiated with a target wireless communication device that is not configured with quality of service and preconditions as mandatory, and wherein the target wireless communication device is at a home network.

33. The method of claim 27, wherein a precondition option-tag within a request for the voice over Internet Protocol call indicates that an originating wireless communication device is configured to use a precondition mechanism.

34. The method of claim 27, wherein the wireless communication device is configured to use a precondition mechanism.

35. The method of claim 27, wherein the wireless communication device is configured to use a protocol for session configuration that uses precondition headers.

36. The method of claim 27, wherein the wireless communication device comprises a session initiation protocol client.

37. The method of claim 27, wherein the wireless communication device comprises a voice over Internet Protocol client.

38. The method of claim 27, wherein the wireless communication device comprises a video telephony client.

39. The method of claim 27, wherein the wireless communication device comprises an Internet Protocol multimedia system client.

40. A computer-program product, the computer-program product comprising a non-transitory computer-readable medium having instructions thereon, the instructions comprising:
code for causing a wireless communication device to roam on a network;
code for causing the wireless communication device to initiate a voice over Internet Protocol call;
code for causing the wireless communication device to receive a response from the network;
code for causing the wireless communication device to determine quality of service capabilities of the network from the response;
code for causing the wireless communication device to determine precondition capabilities of the network from the response; and
code for causing the wireless communication device to proceed with the voice over Internet Protocol call without quality of service preconditions.

41. The computer-program product of claim 40, wherein the network is an Internet Protocol multimedia system core network.

42. The computer-program product of claim 40, wherein the response does not comprise precondition headers, and wherein the Internet Protocol multimedia system core network does not support quality of service preconditions.

43. The computer-program product of claim 40, wherein the response does not comprise precondition headers, and wherein quality of service is not mandatory for the Internet Protocol multimedia system core network.

44. An apparatus configured for wireless communication, comprising:
means for receiving a voice over Internet Protocol call initiation from an originating wireless communication device, wherein the originating wireless communication device is roaming on a network that does not support quality of service preconditions;
means for removing quality of service precondition headers from the voice over Internet Protocol call initiation;
means for forwarding the voice over Internet Protocol call initiation to a target wireless communication device;
means for receiving a response from the target wireless communication device; and
means for forwarding the response to the originating wireless communication device.

45. The apparatus of claim 44, wherein the apparatus is a call session control function.

46. The apparatus of claim 44, wherein the call session control function is part of an Internet Protocol multimedia system core network.

47. The apparatus of claim 44, further comprising means for removing quality of service precondition headers from the response if the response comprises quality of service precondition headers.

48. The apparatus of claim 44, wherein the target wireless communication device is an intended recipient of the voice over Internet Protocol call.

49. The apparatus of claim 44, wherein the response forwarded to the originating wireless communication device does not comprise precondition headers, and wherein the network does not support quality of service preconditions.

50. The apparatus of claim 44, wherein the response forwarded to the originating wireless communication device does not comprise precondition headers, and wherein quality of service is not mandatory for the network.

51. An apparatus, comprising:
circuitry configured to receive a voice over Internet Protocol call initiation from an originating wireless communication device, wherein the originating wireless communication device is roaming on a network that does not support quality of service preconditions, to remove quality of service precondition headers from the voice over Internet Protocol call initiation, to forward the voice over Internet Protocol call initiation to a target wireless communication device, to receive a response from the target wireless communication device, and to forward the response to the originating wireless communication device.

52. The apparatus of claim 51, wherein the apparatus is a call session control function.

53. The apparatus of claim 52, wherein the call session control function is part of an Internet Protocol multimedia system core network.

54. The apparatus of claim 51, wherein the circuitry is further configured to remove quality of service precondition headers from the response if the response comprises quality of service precondition headers.

55. The apparatus of claim 51, wherein the target wireless communication device is an intended recipient of the voice over Internet Protocol call.

56. The apparatus of claim 51, wherein the response forwarded to the originating wireless communication device does not comprise precondition headers, and wherein the network does not support quality of service preconditions.

57. The apparatus of claim 51, wherein the response forwarded to the originating wireless communication device does not comprise precondition headers, and wherein quality of service is not mandatory for the network.

58. A method for wireless communication, comprising:
receiving a voice over Internet Protocol call initiation from an originating wireless communication device, wherein the originating wireless communication device is roaming on a network that does not support quality of service preconditions;
removing quality of service precondition headers from the voice over Internet Protocol call initiation;
forwarding the voice over Internet Protocol call initiation to a target wireless communication device;
receiving a response from the target wireless communication device; and
forwarding the response to the originating wireless communication device

59. The method of claim 58, wherein the method is performed by a call session control function.

60. The method of claim 59, wherein the call session control function is part of an Internet Protocol multimedia system core network.

61. The method of claim 58, further comprising removing quality of service precondition headers from the response if the response comprises quality of service precondition headers.

62. The method of claim 58, wherein the target wireless communication device is an intended recipient of the voice over Internet Protocol call.

63. The method of claim 58, wherein the response forwarded to the originating wireless communication device does not comprise precondition headers, and wherein the network does not support quality of service preconditions.

64. The method of claim 58, wherein the response forwarded to the originating wireless communication device does not comprise precondition headers, and wherein quality of service is not mandatory for the network.

65. A computer-program product, the computer-program product comprising a non-transitory computer-readable medium having instructions thereon, the instructions comprising:
code for causing a wireless device to receive a voice over Internet Protocol call initiation from an originating wireless communication device, wherein the originating wireless communication device is roaming on a network that does not support quality of service preconditions;
code for causing the wireless device to remove quality of service precondition headers from the voice over Internet Protocol call initiation;
code for causing the wireless device to forward the voice over Internet Protocol call initiation to a target wireless communication device;
code for causing the wireless device to receive a response from the target wireless communication device; and
code for causing the wireless device to forward the response to the originating wireless communication device.

66. The computer-program product of claim 65, wherein the wireless device is a call session control function.

67. The computer-program product of claim 66, wherein the call session control function is part of an Internet Protocol multimedia system core network.

68. The computer-program product of claim 65, wherein the instructions further comprise code for causing the wireless device to remove quality of service precondition headers from the response if the response comprises quality of service precondition headers.
